(19) United States
(12) Patent Application Publication
(10) Pub. No.: US 2025/0324327 A1
(43) Pub. Date: Oct. 16, 2025

(54) TERRESTRIAL NETWORK AND NON-TERRESTRIAL NETWORK MOBILITY

(71) Applicant: QUALCOMM Incorporated, San Diego, CA (US)

(72) Inventors: Bharat SHRESTHA, San Diego, CA (US); Umesh PHUYAL, San Diego, CA (US); Prasad Reddy KADIRI, San Diego, CA (US); Luis Fernando Brisson LOPES, Swindon (GB); Geetha Priya RAJENDRAN, Bangalore (IN)

(21) Appl. No.: 18/863,005

(22) PCT Filed: Jul. 27, 2023
(86) PCT No.: PCT/US2023/071146

§ 371 Date: Nov. 5, 2024

(30) Foreign Application Priority Data
Aug. 3, 2022 (IN) 202241044375

(51) Int. Cl. H04W 36/00; H04W 36/08; H04W 36/14

(52) U.S. Cl. CPC H04W 36/0055; H04W 36/08; H04W 36/14

(57) ABSTRACT

Various aspects of the present disclosure generally relate to wireless communication. In some aspects, a network node may attempt to obtain capability information relating to a mobility operation of a user equipment (UE) transferring from a non-terrestrial network (NTN) to a terrestrial network (TN). The network node may perform at least part of the mobility operation based at least in part on the capability information or attempting to obtain the capability information. Numerous other aspects are described.

### CROSS-REFERENCE TO RELATED APPLICATION

This Patent Application claims priority to India patent application Ser. No. 202240144375, filed on Aug. 3, 2022, entitled “TERRESTRIAL NETWORK AND NON-TERRESTRIAL NETWORK MOBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for terrestrial network (TN) and non-terrestrial network (NTN) mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include attempting to obtain capability information relating to a mobility operation of a user equipment (UE) transferring between a non-terrestrial network (NTN) and a terrestrial network (TN). The method may include performing at least part of the mobility operation based at least in part on the capability information or attempting to obtain the capability information.

Some aspects described herein relate to a method of wireless communication performed by a network node. The method may include triggering a mobility operation associated with transferring a UE between an NTN and a TN based at least in part on at least one of, capability information associated with the UE and relating to the mobility operation, or whether the capability information is available to the network node. The method may include outputting a message for the UE based at least in part on the capability information.

Some aspects described herein relate to a method of wireless communication performed by a UE. The method may include receiving a trigger for a mobility operation associated with the UE between an NTN and a TN. The method may include performing at least part of the mobility operation based at least in part on having transmitted capability information indicating a capability of the UE associated with the mobility operation or aborting the mobility operation based at least in part on not having transmitted the capability information.

Some aspects described herein relate to a network node for wireless communication. The network node may include a memory and one or more processors coupled to the memory. The one or more processors may be configured to attempt to obtain capability information relating to a mobility operation of a UE transferring between an NTN and a TN. The one or more processors may be configured to perform at least part of the mobility operation based at least in part on the capability information or attempting to obtain the capability information.

Some aspects described herein relate to a network node for wireless communication. The network node may include a memory and one or more processors coupled to the memory. The one or more processors may be configured to trigger a mobility operation associated with transferring a UE between an NTN and a TN based at least in part on at least one of. The one or more processors may be configured to output a message for the UE based at least in part on the capability information.

Some aspects described herein relate to a UE for wireless communication. The user equipment may include a memory and one or more processors coupled to the memory. The one or more processors may be configured to receive a trigger for a mobility operation associated with the UE between an NTN and a TN. The one or more processors may be configured to perform at least part of the mobility operation based at least in part on having transmitted capability information indicating a capability of the UE associated with the mobility operation or aborting the mobility operation based at least in part on not having transmitted the capability information.

Some aspects described herein relate to a non-transitory computer-readable medium that stores a set of instructions for wireless communication by a network node. The set of instructions, when executed by one or more processors of the network node, may cause the network node to attempt to obtain capability information relating to a mobility operation of a UE transferring between an NTN and a TN. The set of instructions, when executed by one or more processors of the network node, may cause the network node to perform at least part of the mobility operation based at least in part on the capability information or attempting to obtain the capability information.

Some aspects described herein relate to a non-transitory computer-readable medium that stores a set of instructions for wireless communication by a network node. The set of instructions, when executed by one or more processors of the network node, may cause the network node to trigger a mobility operation associated with transferring a UE between an NTN and a TN based at least in part on at least one of. The set of instructions, when executed by one or more processors of the network node, may cause the network node to output a message for the UE based at least in part on the capability information.

Some aspects described herein relate to a non-transitory computer-readable medium that stores a set of instructions for wireless communication by a UE. The set of instructions, when executed by one or more processors of the UE, may cause the UE to receive a trigger for a mobility operation associated with the UE between an NTN and a TN. The set of instructions, when executed by one or more processors of the UE, may cause the UE to perform at least part of the mobility operation based at least in part on having transmitted capability information indicating a capability of the UE associated with the mobility operation or aborting the mobility operation based at least in part on not having transmitted the capability information.

Some aspects described herein relate to an apparatus for wireless communication. The apparatus may include means for attempting to obtain capability information relating to a mobility operation of a UE transferring between an NTN and a TN. The apparatus may include means for performing at least part of the mobility operation based at least in part on the capability information or attempting to obtain the capability information.

Some aspects described herein relate to an apparatus for wireless communication. The apparatus may include means for triggering a mobility operation associated with transferring a UE between an NTN and a TN based at least in part on at least one of, capability information associated with the UE and relating to the mobility operation, or whether the capability information is available to the network node. The apparatus may include means for outputting a message for the UE based at least in part on the capability information.

Some aspects described herein relate to an apparatus for wireless communication. The apparatus may include means for receiving a trigger for a mobility operation associated with the UE between an NTN and a TN. The apparatus may include means for performing at least part of the mobility operation based at least in part on having transmitted capability information indicating a capability of the UE associated with the mobility operation or aborting the mobility operation based at least in part on not having transmitted the capability information.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of wireless networks including a terrestrial network (TN) and a non-terrestrial network (NTN), in accordance with the present disclosure.

FIG. 5 is a diagram illustrating an example of signaling of capability information associated with a UE transferring from an NTN to a TN, in accordance with the present disclosure.

FIG. 6 is a diagram illustrating an example of an X2 interface based handover mobility operation, in accordance with the present disclosure.

FIG. 7 is a diagram illustrating an example of an S1 application protocol (AP) based handover mobility operation, in accordance with the present disclosure.

FIG. 8 is a diagram illustrating an example of a radio resource control (RRC) release based redirection mobility operation, in accordance with the present disclosure.

FIG. 9 is a diagram illustrating an example of a redirection mobility operation involving an early data transmission (EDT) or a preconfigured uplink resource (PUR), in accordance with the present disclosure.

FIG. 10 is a diagram illustrating an example process performed, for example, by a network node, in accordance with the present disclosure.

FIG. 11 is a diagram illustrating an example process performed, for example, by a network node, in accordance with the present disclosure.

FIG. 12 is a diagram illustrating an example process performed, for example, by a UE, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

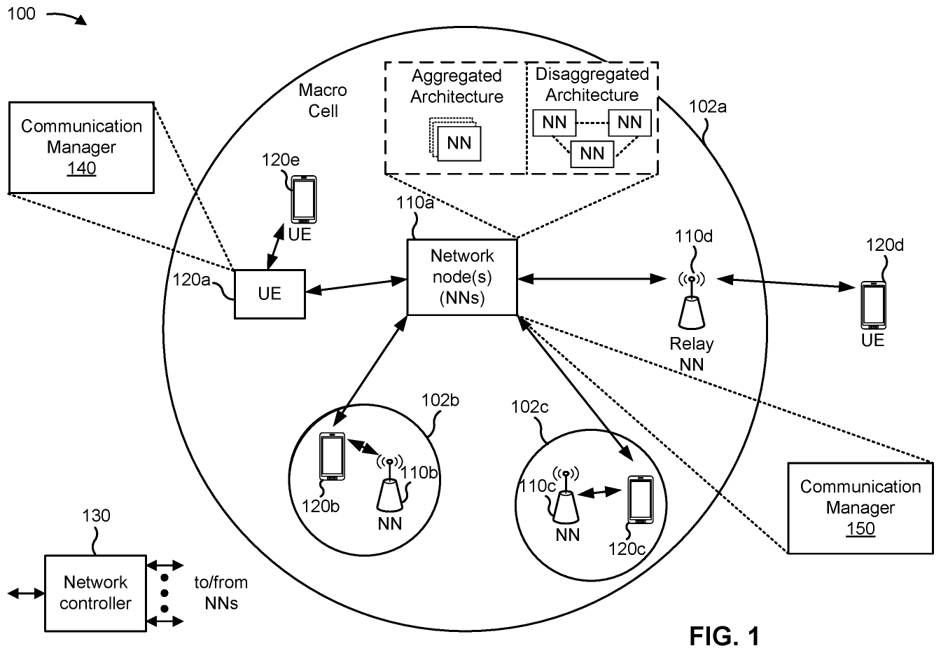

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52. 6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., network node 110) may include a communication manager 150. As described in more detail elsewhere herein, the communication manager 150 may attempt to obtain capability information relating to a mobility operation of a UE transferring from a NTN to a TN; and perform at least part of the mobility operation based at least in part on the capability information or attempting to obtain the capability information. Additionally, or alternatively, the communication manager 150 may perform one or more other operations described herein.

In some aspects, the communication manager 150 may trigger a mobility operation associated with transferring a UE from an NTN to a TN based at least in part on at least one of: capability information associated with the UE and relating to the mobility operation, or whether the capability information is available to the network node; and output a message for the UE based at least in part on the capability information. Additionally, or alternatively, the communication manager 150 may perform one or more other operations described herein.

In some aspects, the UE 120 may include a communication manager 140. As described in more detail elsewhere herein, the communication manager 140 may receive a trigger for a mobility operation associated with the UE from an NTN to a TN: and perform at least part of the mobility operation based at least in part on having transmitted capability information indicating a capability of the UE associated with the mobility operation or aborting the mobility operation based at least in part on not having transmitted the capability information. Additionally, or alternatively, the communication manager 140 may perform one or more other operations described herein.

As indicated above, FIG. 1 is provided as an example. Other examples may differ from what is described with regard to FIG. 1.

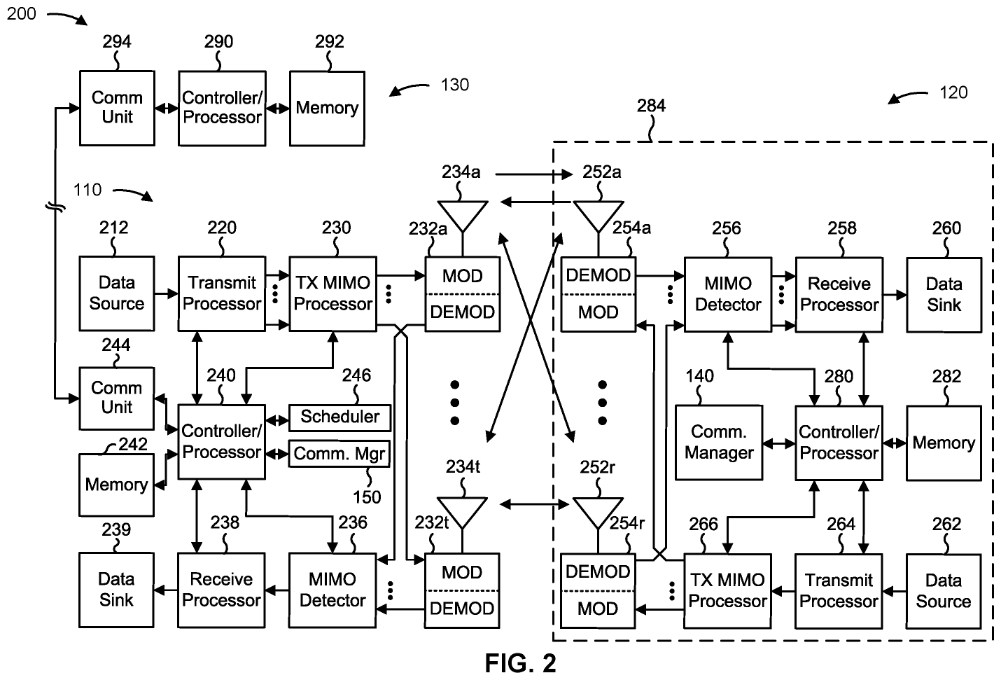

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

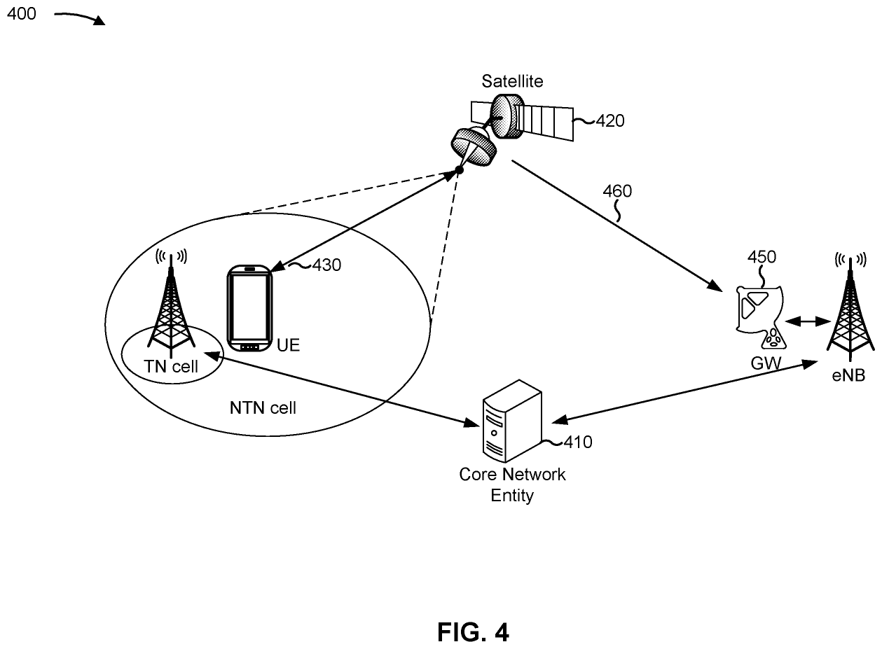

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

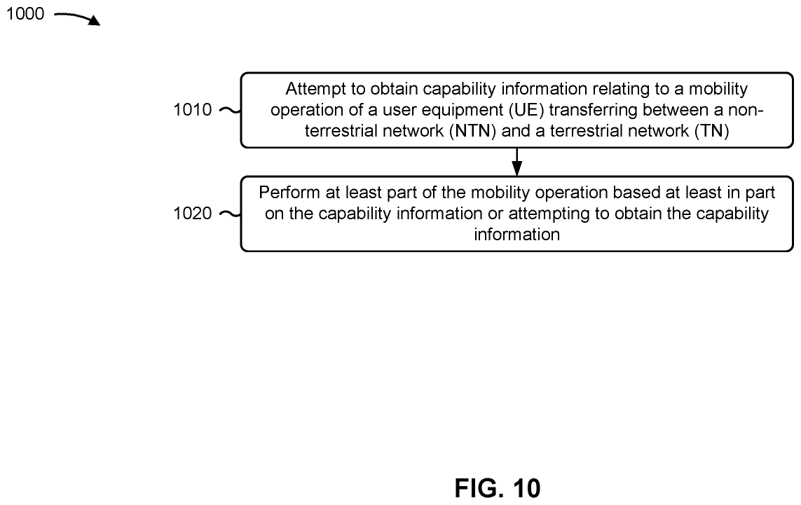

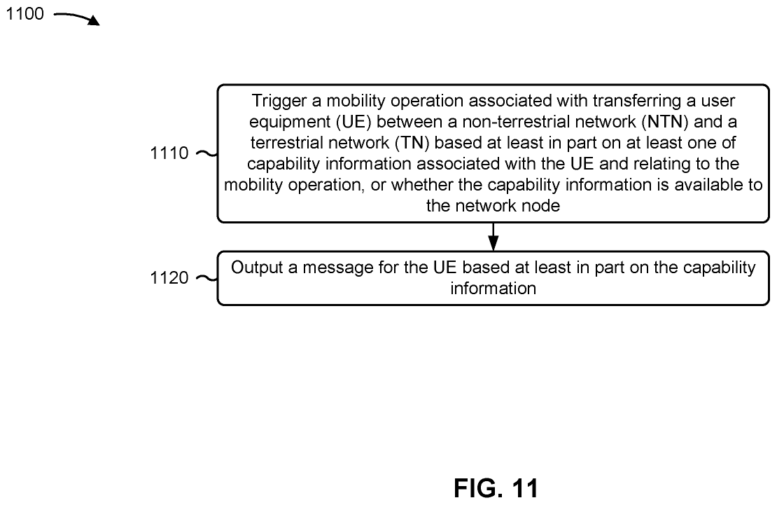

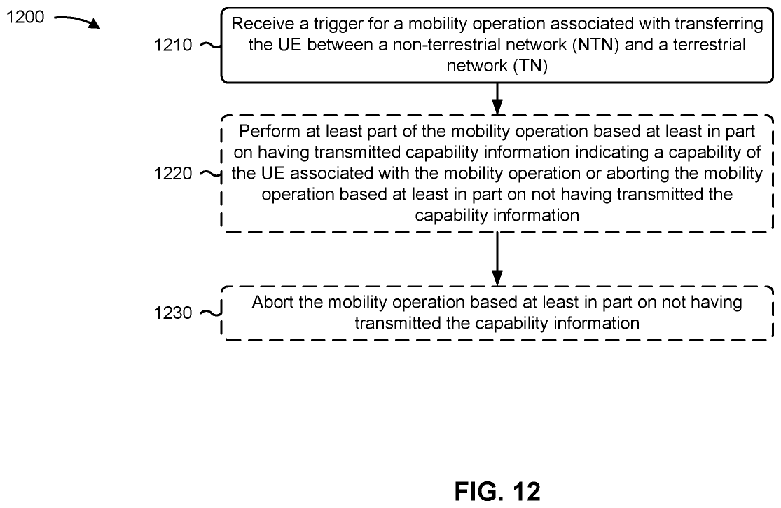

The controller/processor 240 of the network node 110, the controller/processor 280 of the UE 120, and/or any other component(s) of FIG. 2 may perform one or more techniques associated with mobility operations, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

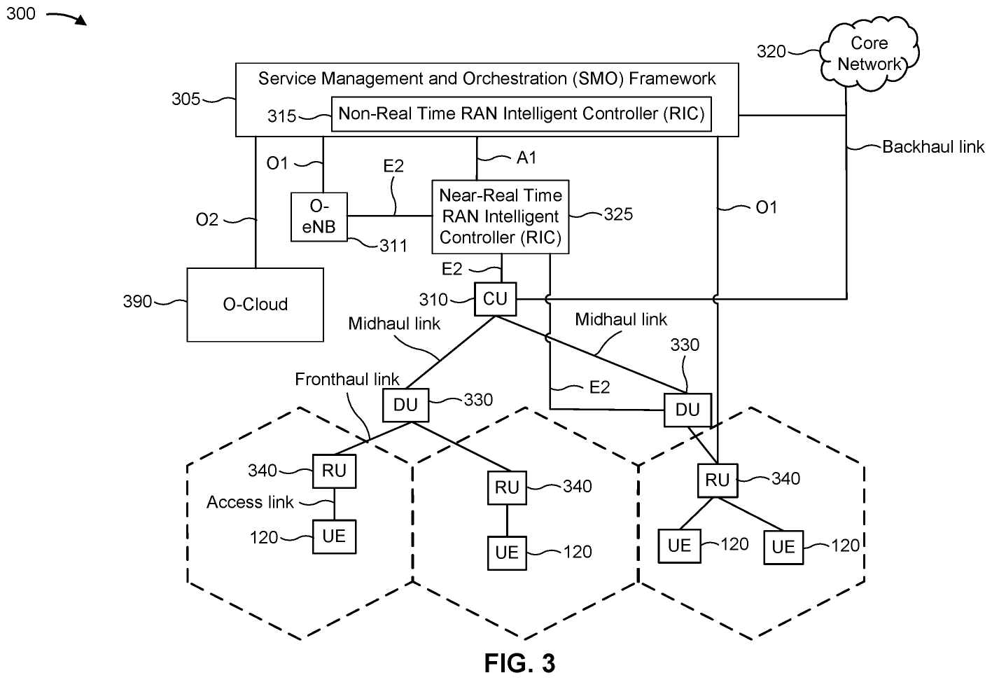

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of wireless networks including a terrestrial network (TN) and a non-terrestrial network (NTN). A core network entity 410 (in example 400, a mobility management entity (MME)) may support both the TN and the NTN. For example, the core network entity 410 may manage operations of the TN and the NTN, such as network access control, radio resource management, mobility management, roaming management, and tracking area management, among other examples. While the core network entity 410 of example 400 is an MME, in some aspects, the core network entity may be a different entity, such as one or more entities of an evolved packet core (EPC), one or more entities of a 5G core (5GC), one or more entities of a 6G network (e.g., a 6G core network), or a combination thereof. In some aspects, an eNB (or a gNB, a set of network nodes 110, or the like) may support connection, by a UE 120, via both the TN (e.g., the network node 110) and the NTN (e.g., satellite 420)

The TN is associated with a network node 110. For example, the network node 110 may provide a cell (illustrated as a TN cell) to which UEs can connect to access the TN. The NTN is served by a satellite 420. For example, the satellite 420 may provide a cell (illustrated as an NTN cell) to which UEs can connect to access the NTN. As mentioned above, an MME or an eNB (or a gNB, a set of network nodes 110, or the like) may support connection, by the UE 120, to a network (e.g., a public land mobile network (PLMN)) via the TN and the NTN. For example, the UE may be configured with equivalent PLMNs (e.g., PLMN parameters) for (e.g., belonging to) both the TN and the NTN. A PLMN associated with the configured equivalent PLMNs may support both the TN and the NTN. Therefore, if the UE enters a radio link failure state or a suspended state with regard to a connection to one network (of the TN or the NTN), the UE may be able to continue the connection on the other network (of the TN or the NTN). This may provide improved coverage and reliability, particularly for UEs that are only intermittently covered by TN cells.

In some examples, an NTN may use a transparent satellite deployment, which may also be referred to as a bent-pipe satellite deployment. In a transparent satellite deployment, the satellite 420 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in FIG. 4 may be associated with a Global Navigation Satellite System (GNSS) capability or a Global Positioning System (GPS) capability, though not all UEs have such capabilities. The satellite 420 may provide a cell (shown as an NTN cell) that covers the UE 120.

In some aspects, an NTN may use a regenerative satellite deployment. In a regenerative satellite deployment, a UE 120 is served by a satellite via a service link. For example, the satellite may include a network node 110 (e.g., network node 110a). In some aspects, the satellite may be referred to as a non-terrestrial base station, a regenerative repeater, or an on-board processing repeater. In some aspects, the satellite may demodulate an uplink radio frequency signal, and may modulate a baseband signal derived from the uplink radio signal to produce a downlink radio frequency transmission. The satellite may transmit the downlink radio frequency signal on the service link. The satellite may provide a cell that covers the UE.

The service link 430 may include a link between the satellite 420 and the UE 120, and may include one or more of an uplink or a downlink. The feeder link 460 may include a link between the satellite 420 and the gateway 450, and may include one or more of an uplink (e.g., from the UE 120 to the gateway 450) or a downlink (e.g., from the gateway 450 to the UE 120).

A UE can perform a mobility operation to select a new serving cell for the UE. For example, the mobility operation can include a handover (in which a UE's primary serving cell is changed from a first cell, provided by a first network node, to a second cell provided by a second network node), an RRC connection release and redirection (in which a UE is configured to an RRC idle mode and instructed to prioritize a target cell for reestablishment of an RRC connection), or a tracking area update (TAU) procedure (in which the UE initiates the updating of a tracking area of the UE for idle mode). A tracking area (identified by a tracking area identity) is part of a tracking area identity (TAI) parameter used for registration with the core network entity 410, where the TAI parameter indicates a mobile country code (MCC), a mobile network code (MNC), and a tracking area code (TAC). Some types of mobility operation may involve the transfer of information between network nodes, such as a source network node that provides a source cell of a mobility operation and a target network node that provides a target cell of the mobility operation. A source cell is a serving cell of the UE prior to performing the mobility operation. A target cell is a selected cell of the mobility operation, to which the UE connects if the mobility operation is successful. As used herein, a mobility operation is referred to as transferring the UE from a source cell (or a source network, or a source network node) to a target cell (or a target network, or a target network node). The UE's connection (e.g., RRC connection) may or may not be maintained during the transfer, depending on the type of mobility operation.

A UE may report capability information (sometimes referred to as UE capability information) that indicates features or operations supported by the UE. Capability information is generally reported to the network to which the UE is connected. For example, if the UE is connected to a TN of example 400, the UE may report capability information to a network node 110 of the TN. If the UE is connected to an NTN of example 400, the UE may report capability information to a network node 110 of the NTN. A TN may support capability information regarding a mobility operation transferring the UE from the TN to an NTN. For example, the UE may transmit capability information in a UE capability TN container (e.g., an E-UTRA capability information element (IE) indicating E-UTRA UE radio access capability parameters), where the capability information includes an IE (e.g., ntn-Connectivity-EPC or ntn-Connectivity-EPC-r17) indicating whether the UE supports NTN access when connected to an EPC (e.g., associated with a TN). However, while a TN supports capability information regarding transferring the UE from the TN to an NTN, this information may not indicate whether the UE can be transferred from an NTN to a TN. Thus, a target network node (e.g., a target eNB) may not have information indicating whether the UE can be transferred from an NTN to a TN associated with the target network node. This may negatively impact mobility operations, such as handover, RRC reestablishment, capability updating via non-access stratum (NAS) signaling, and UE capability handling by the core network. Thus, the reliability of mobility operations may be decreased and the interoperability of TNs and NTNs may be reduced.

Some techniques described herein provide capability information relating to a mobility operation of a UE transferring from an NTN to a TN. For example, the capability information may indicate whether the UE can be transferred to a TN (e.g., associated with an EPC) when connected to an NTN. Some techniques described herein provide signaling related to the capability information, such as for providing the capability information via a network node or a core network entity, or for providing the capability information in association with a TAU update. Furthermore, some techniques described herein provide mobility operations based at least in part on the capability information, such as an X2 based handover, an S1 application protocol (S1-AP) based handover, RRC release and redirection, and mobility operations based on early data transmission (EDT) or preconfigured uplink resource (PUR) configurations. In this way, the reliability of mobility operations between NTNs and TNs is improved, and interoperability of TNs and NTNs is improved. This may be particularly beneficial in the context of Internet of Things (IoT) NTNs.

As indicated above, FIG. 4 is provided as an example. Other examples may differ from what is described with regard to FIG. 4.

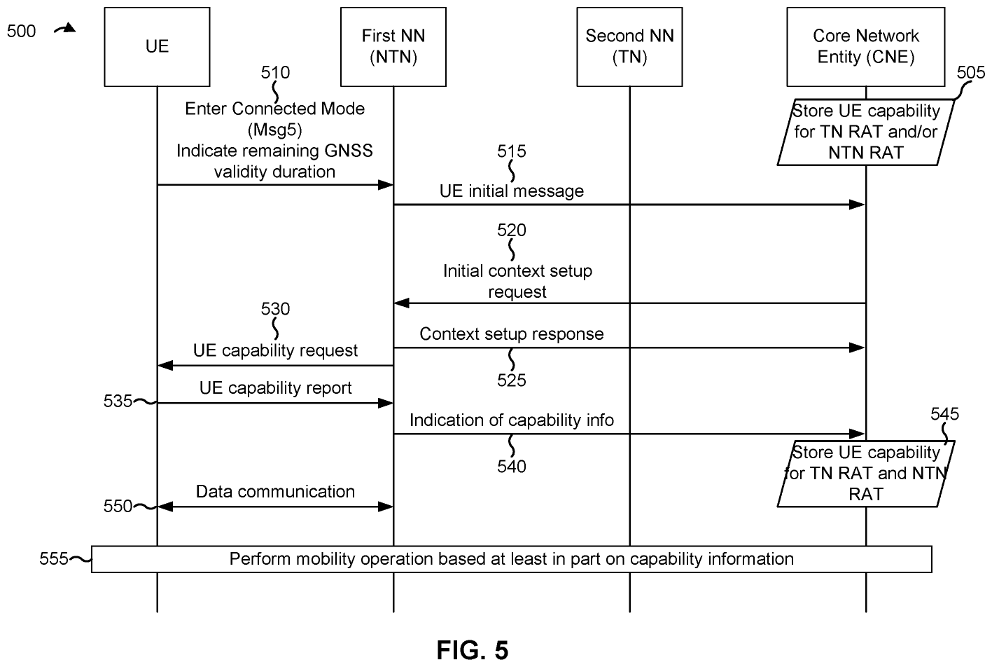

FIG. 5 is a diagram illustrating an example 500 of signaling of capability information associated with a UE transferring from an NTN to a TN, in accordance with the present disclosure. As shown, example 500 includes a UE (e.g., UE 120), a first network node (e.g., network node 110), a second network node (e.g., network node 110), and a core network entity (e.g., core network entity 410). In some aspects, the core network entity may be an MME. The first network node of example 500 may be associated with an NTN. For example, the first network node of example 500 may include or be part of an eNB associated with an NTN, such as an eNB implemented on a satellite or an eNB communicating with a satellite via a feeder link, as described in connection with FIG. 4. The second network node of example 500 may be associated with an NTN. For example, the second network node of example 500 may include or be part of an eNB associated with a TN, as described in connection with FIG. 4.

As shown, the core network entity may store or have access to capability information 505 regarding transferring the UE from a TN to an NTN. This capability information 505 may be referred to as capability information for a TN RAT. For example, the capability information 505 may be provided, by the UE for the second network node, in a UE capability TN container (e.g., an E-UTRA capability IE indicating E-UTRA UE radio access capability parameters). The capability information 505 may include an IE (e.g., ntn-Connectivity-EPC or ntn-Connectivity-EPC-r17) indicating whether the UE supports NTN access when connected to an EPC (e.g., associated with a TN), such as an EPC including the core network entity of example 500. The core network entity may receive the capability information 505 from the second network node (not shown). In some aspects, the capability information indicates whether the UE supports a same set of capabilities, for performing mobility operations, for an NTN radio access technology and a TN radio access technology.

As shown by reference number 510, the UE may enter a connected mode with the first network node. For example, the UE and the first network node may establish an RRC connection, such as based at least in part on a random access channel (RACH) message 5 (which may include, for example, an RRC reconfiguration complete message or a message defined by a fifth step of a four-step RACH procedure). As further shown, the RACH message 5 may indicate a remaining GNSS validity duration. As shown by reference number 515, the first network node may provide a UE initial message to the core network entity.

As shown by reference number 520, the core network entity may provide an initial context setup request to the first network node. The initial context setup request may indicate that the core network entity has not received capability information 535 from the first network node or the UE. The capability information 535 may relate to a mobility operation of the UE transferring from an NTN to a TN, as described in more detail below. As shown by reference number 525, the first network node may provide a context setup response to the core network entity.

As shown, the first network node may provide, for the UE, a UE capability request 530. The UE capability request 530 may request capability information 535 from the UE, such as based at least in part on the initial context setup request indicating that the core network entity has not received the capability information 535.

As shown, the UE may transmit the capability information 535. For example, the UE may transmit a UE capability report indicating the capability information 535. The capability information 535 may indicate whether the UE can be transferred to a TN (e.g., associated with an EPC, a 5GC, or a UTRA network) when connected to an NTN (e.g., the NTN associated with the network node of FIG. 5). In some aspects, the capability information 535 may indicate one or more bands supported by the UE. For example, the capability information 535 may be per band. In some aspects, the capability information 535 may include a bit indicating whether the UE can be transferred to a TN when connected to an NTN. As shown by reference number 540, the first network node may provide an indication of the capability information 535 to the core network entity. For example, the indication may include the capability information 535. As shown by reference number 545, the core network entity may store or have access to the capability information 505 and the capability information 535. As shown by reference number 550, the UE may perform uplink or downlink data communication, such as via the NTN associated with the first network node and the core network entity.

As shown by reference number 555, two or more of the UE, the first network node, the second network node, and the core network entity may perform a mobility operation. For example, the UE may perform one or more steps of the mobility operation (e.g., at least part of the mobility operation). As another example, the first network node (e.g., a source network node or a target network node of the mobility operation) may perform one or more steps of the mobility operation (e.g., at least part of the mobility operation). As another example, the second network node (e.g., a source network node or a target network node of the mobility operation) may perform one or more steps of the mobility operation (e.g., at least part of the mobility operation). As another example, the core network entity may perform one or more steps of the mobility operation (e.g., at least part of the mobility operation). The UE, the first network node, the second network node, and/or the core network entity may perform the mobility operation based at least in part on the capability information 505 and/or the capability information 535. For example, if the mobility operation involves transferring the UE from a TN associated with the first network node to an NTN associated with the second network node, the mobility operation may be based at least in part on the capability information 505. As another example, if the mobility operation involves transferring the UE from an NTN associated with the second network node to a TN associated with the first network, the mobility operation may be based at least in part on the capability information 535. The mobility operation may be based at least in part on the capability information 535 because a target network node may be selected according to the capability information 535 (e.g., a target network node associated with a band for which the UE supports transferring from an NTN to a TN, or a target network associated with a TN due to the UE supporting transferring from the NTN to the TN).

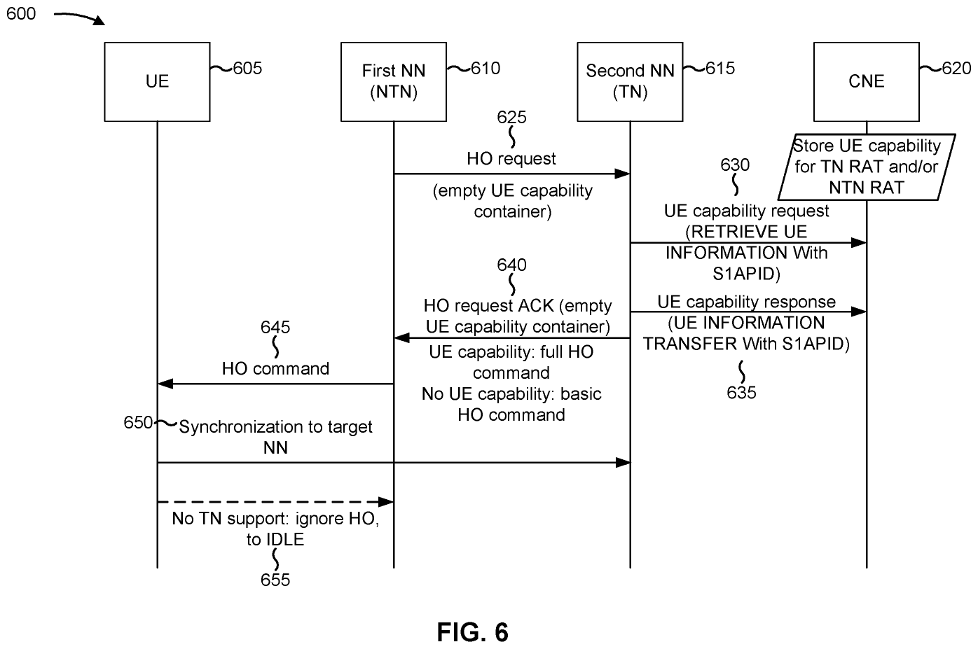

The mobility operation may include, for example, an X2 interface based handover, an S1-AP based handover, an RRC release based redirection, an EDT based redirection, a PUR based redirection, an RACH-less redirection, or a TAU update. Particular examples of the mobility operation, and examples of mobility operations in scenarios where a target network node fails to obtain the capability information 535, are provided in FIGS. 6-9.

As indicated above, FIG. 5 is provided as an example. Other examples may differ from what is described with regard to FIG. 5.

FIG. 6 is a diagram illustrating an example 600 of an X2 interface based handover mobility operation, in accordance with the present disclosure. In an X2 interface based handover, a UE's primary serving cell is changed from a first network node to a second network node, where the first network node and the second network node are connected using an X2 interface. Example 600 is also applicable for an Xn interface based handover between network nodes connected using an Xn interface.

Example 600 includes a UE 605 (e.g., UE 120), a source network node 610 (e.g., network node 110), a target network node 615 (e.g., network node 110), and a core network entity 620 (e.g., the core network entity 410 of FIG. 4). In example 600, the source network node is associated with an NTN and the target network node is associated with a TN. For example, the UE 605 may be connected to the NTN (e.g., the source network node associated with the NTN). As shown, in some examples, the core network entity 620 may store or have access to capability information, such as capability information associated with transferring from a TN to an NTN (e.g., capability information 505) and/or capability information associated with transferring from an NTN to a TN (e.g., capability information 535). In some aspects, the core network entity 620 may store or have access to only the capability information associated with transferring from the TN to the NTN. In some aspects, the core network entity 620 may store or have access to only the capability information associated with transferring from the NTN to the TN. In some aspects, the core network entity 620 may store or have access to the capability information associated with transferring from the TN to the NTN and the capability information associated with transferring from the NTN to the TN. The techniques described with regard to example 600 can also be applied for a mobility operation transferring the UE 605 from the TN to the NTN.

As shown, the source network node 610 may provide a handover request 625 to the target network node 615. The handover request 625 may indicate, for example, an identity of the source network node 610, a cause of the handover, an identifier of the target network node 615, a UE context, or the like.

Thus, the source network node 610 may trigger a mobility operation associated with transferring the UE 605 from an NTN to a TN. The source network node 610 may trigger the mobility operation based at least in part on at least one of the capability information associated with transferring from the NTN to the TN, or whether the capability information is available at the source network node 610.

For example, the handover request 625 may indicate, to the target network node 615, that no capability information associated with transferring from the NTN to the TN is available, and that the target network node 615 is to attempt to obtain the capability information from the core network entity 620 (e.g., instead of sending an “X2 handover (HO) failure” message to the source network node 610). In this case, triggering the mobility operation may include outputting, to the target network node 615 of the mobility operation, a handover request 625 including an empty UE capability container based at least in part on the capability information not being available to the source network node 610. For example, the empty UE capability container may indicate that the capability information is not available to the source network node 610. For example, the source network node 610 may create a source to target transparent container such that a UE radio capability container is empty within an S1 handover required message.

In some aspects, the target network node 615 may identify that the source network node 610 is of a different network type (e.g., TN or NTN), and may initiate a UE capability request to the core network entity 620 without checking the UE capability container received from the source network node 610. An IE may be added to Xn (e.g., X2) setup served cell information to inform neighbor cells (e.g., network nodes) of the cell network type as TN or NTN. In some aspects, the target network node 615 may identify that the source network node 610 is of the different network type based at least in part on a cause value indicating NTN to TN mobility, or a cause value indicating TN to NTN mobility. In some aspects, the target network node 615 may identify that the source network node 610 is of the different network type based at least in part on an eNB identity of the source network node 610. Thus, the target network node 615 may request the capability information from the core network entity 620 based at least in part on the mobility operation being from the NTN to the TN. For example, the target network node 615 may determine that the mobility operation is from the NTN to the TN based at least in part on an indication, from a source network node 610 of the UE 605, of whether the source network node 610 is associated with the NTN or the TN.

In some aspects, the source network node 610 may make a handover decision. However, the source network node 610 may not know or have access to information indicating the UE 605's capability for a target network type (e.g., for transferring from an NTN to a TN). The source network node 610 may request the core network entity 620 to send the UE 605's capability information for a target network type (e.g., for transferring from an NTN to a TN). Thus, the source network node 610 may request the capability information from the core network entity 620. If the core network entity 620 has stored the capability information for the UE 605, the core network entity 620 may transfer the UE 605's capability information regarding the target network type to the source network node 610. Otherwise, the source network node 610 may determine that handover is not possible, and may release the UE 605 with redirection to the target network node 615, as described elsewhere herein. Thus, the source network node 610 may determine that the capability information is not received, and a message to the UE 605 may include an indication for the UE 605 to enter an idle mode (based at least in part on the capability information not being available to the network node). As used herein, “releasing the UE” may include providing an indication for the UE to enter an idle mode (e.g., an RRC idle mode).

As shown, the target network node 615 may provide a UE capability request 630 to the core network entity 620. Thus, the target network node 615 may attempt to obtain the capability information relating to the mobility operation of the UE transferring from the NTN to the TN by requesting the capability information from the core network entity 620. In some aspects, requesting the capability information (e.g., via the UE capability request 630) from the core network entity 620 is based at least in part on an indication (e.g., a handover request 625 including an empty UE capability container), from a source network node 610 of the UE 605, that the capability information is not available at the source network node. The UE capability request may indicate an S1-AP identifier (e.g., of the target network node 615).

As shown, the core network entity 620 may provide a UE capability response 635 to the target network node 615. If the core network entity 620 has stored or has access to capability information regarding transferring from an NTN to a TN, the UE capability response 635 may include the capability information. If the core network entity 620 has not stored or does not have access to capability information regarding transferring from the NTN to the TN, then the capability response 635 may omit the capability information. As further shown, the UE capability response 635 may indicate an S1-AP identifier received in the UE capability request 630.

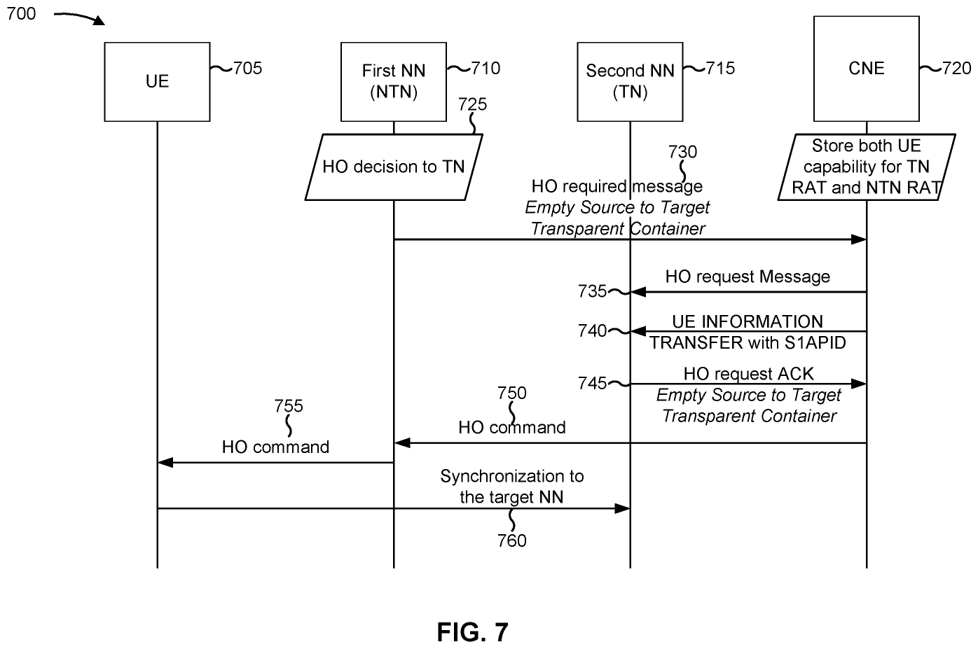

As shown, the target network node 615 may provide a handover request acknowledgment 640 to the source network node 610. If the target network node 615 cannot obtain capability information regarding transferring from the NTN to the TN, then the target network node 615 may initiate a basic handover. A basic handover may include a handover with a minimum required capability for an RRC connection. For example, a basic handover may be equivalent to an RRC connection setup (if the UE 605 supports transferring from an NTN to a TN) or an RRC release (if the UE 605 does not support transferring from the NTN to the TN). Thus, the target network node 615 may fail to obtain the capability information (e.g., from the core network entity 620), and may trigger a handover associated with a minimum required capability for an RRC connection (e.g., a basic handover) based at least in part on failing to obtain the capability information. In the case of an S1-AP based handover (described with regard to FIG. 7), the target network node 615 may request for the core network entity 620 to release the UE 605, and the core network entity 620 may initiate the RRC release procedure.

In some aspects, if the target network node 615 determines (e.g., is aware) that the UE 605 does not support a band of the target network node 615 (such as in a TN or an NTN), the target network node 615 may request for the source network node 610 to release the UE 605 to an idle mode. For example, if the capability information indicates that the UE 605 does not support a band of a target radio access technology of the TN or the NTN, performing at least part of the mobility operation may include the target network node 615 requesting that the source network node 610 or the core network entity 620, associated with the UE 605, release the UE 605 to an idle mode. For example, the source network node 610 may obtain, from the target network node 615 of the mobility operation, an indication to release the UE 605 to an idle mode based at least in part on the capability information indicating that the UE cannot transfer from the NTN to the TN.

As shown, the source network node 610 may output a handover command 645 for the UE 605. Thus, the source network node 610 may output a message (e.g., the handover command 645) for the UE 605 based at least in part on the capability information. The handover command 645 may identify the target network node 615, and may indicate for the UE 605 to perform at least part of a mobility operation (i.e., a handover to the target network node 615). As shown by reference number 650, the UE 605 may transfer to the target network node 615. For example, the UE 605 and the target network node 615 may synchronize with each other, as described with regard to FIG. 7, below.

As shown by reference number 655, in some aspects, the UE 605 may ignore the handover command 645, and may enter an idle mode. For example, in some aspects, the UE may receive a handover command 645 indicating for the UE 605 to handover to a target network node 615 associated with a RAT (e.g., TN or NTN) that the UE 605 does not support. In this case, the UE may ignore the handover command 645 and may enter an idle mode.

As indicated above, FIG. 6 is provided as an example. Other examples may differ from what is described with regard to FIG. 6.

FIG. 7 is a diagram illustrating an example 700 of an S1-AP based handover mobility operation, in accordance with the present disclosure. An S1-AP based handover is a mobility operation in which there is not a direct interface (e.g., an X2 or Xn interface) between a source network node and a target network node of the mobility operation. In an S1-AP based handover, a source core network entity (e.g., a source MME) selects a target core network entity associated with a target network node to which a UE is to transfer. Thus, in example 700, the handover may be handled by a core network entity.

Example 700 includes a UE 705 (e.g., UE 120), a source network node 710 (e.g., network node 110), a target network node 715 (e.g., network node 110), and a core network entity 720 (e.g., the core network entity 410 of FIG. 4). The source network node is associated with an NTN and the target network node is associated with an TN. For example, the UE 705 may be connected to the NTN (e.g., the source network node associated with the NTN). As shown, in some examples, the core network entity 720 may store or have access to capability information, such as capability information associated with transferring from a TN to an NTN (e.g., capability information 505) and/or capability information associated with transferring from an NTN to a TN (e.g., capability information 535). In some aspects, the core network entity 720 may store or have access to only the capability information associated with transferring from the TN to the NTN. In some aspects, the core network entity 720 may store or have access to only the capability information associated with transferring from the NTN to the TN. In some aspects, the core network entity 720 may store or have access to the capability information associated with transferring from the TN to the NTN and the capability information associated with transferring from the NTN to the TN. The techniques described with regard to example 700 can also be applied for a mobility operation transferring the UE 705 from the TN to the NTN. For example, the source network node 710 may be associated with the TN and the target network node 715 may be associated with the NTN.

As shown, at reference number 725, the source network node 710 may determine to perform a mobility operation from the NTN to the TN. For example, the source network node 710 may determine that a criterion associated with handover of the UE 705 is satisfied.

As shown, the source network node 710 may provide a handover required message 730 to the core network entity 720. Thus, the source network node 710 may trigger the mobility operation. In some aspects, the handover required message indicates that the mobility operation is from the NTN to the TN. For example, the handover required message 730 may include a handover type IE. The handover type IE may include codepoint (e.g., a value) indicating a handover type (e.g., a handover to an NTN or a handover to a TN) or a field indicating a handover type.

As shown, the core network entity 720 may provide a handover request message 735 to the target network node 715. In some aspects, the core network entity 720 may determine that the handover is between different RAT types (from NTN to TN or vice versa). For example, the core network entity 720 may make this determination based at least in part on a target network node 715's S1-AP identifier, or based at least in part on the handover type IE of the handover required message 730 (if included).

As shown, in some aspects, the core network entity 720 may provide a UE information transfer 740 to the target network node 715. In some aspects, receiving the UE information transfer 740 may be referred to as obtaining, or attempting to obtain, the capability information relating to the mobility operation of the UE transferring from the NTN to the TN. For example, attempting to obtain the capability information may include receiving the capability information from a core network entity. In some aspects, when sending the handover request message 735 from the core network entity 720 to the target network node 715, the core network entity 720 may (e.g., always) include a UE capability container (including the capability information) in the handover request message 735 to provide the capability information to the target network node 715, if the core network entity 720 has stored the capability information. In this example, the UE information transfer 740 may be included in the handover request message 735. For example, the handover request message 735 can be extended to include a UE radio capability (indicating the capability information). As another example, a UE information transfer message (that is, the UE information transfer 740) separate from the handover request message 735 can be used. As yet another example, the UE 705's downlink NAS transport message may (e.g., always) follow the handover request message 735 if the handover is between a TN and an NTN. In this case, a NAS protocol data unit (PDU) field may be an empty string, may be omitted (e.g., not included), or may be ignored by the UE 705. In some aspects, if the core network entity 720 has not stored (or does not have access to) the capability information, the core network entity 720 may provide an indication to perform a basic handover (e.g., with minimum capabilities, as described above) to the target network node 715. This indication may be provided in one or more of the messages described above or in a separate message. As shown, the target network node 715 may provide a handover request acknowledgment 745 to the core network entity 720. The handover request acknowledgment 745 may include an empty source to target transparent container.

As shown, the core network entity 720 may provide a handover command 750 to the source network node 710. For example, the core network entity 720 may provide the handover command 750 based at least in part on the handover request acknowledgment 745. As shown, the source network node 710 may provide the handover command 755 to the UE 705. The handover command 755 may indicate for the UE 705 to perform at least part of a mobility operation transferring the UE 705 from the source network node 710 to the target network node 715.

As shown by reference number 760, the UE 705 may synchronize with the target network node 715. For example, the target network node 715 may output (e.g., transmit, provide for transmission, configure another network node to transmit) one or more reference signals. The UE 705 may synchronize to a timing and/or frequency of the target network node 715 by reference to the one or more reference signals. Thus, the target network node 715 and the UE 705 may synchronize with one another.

As indicated above, FIG. 7 is provided as an example. Other examples may differ from what is described with regard to FIG. 7.

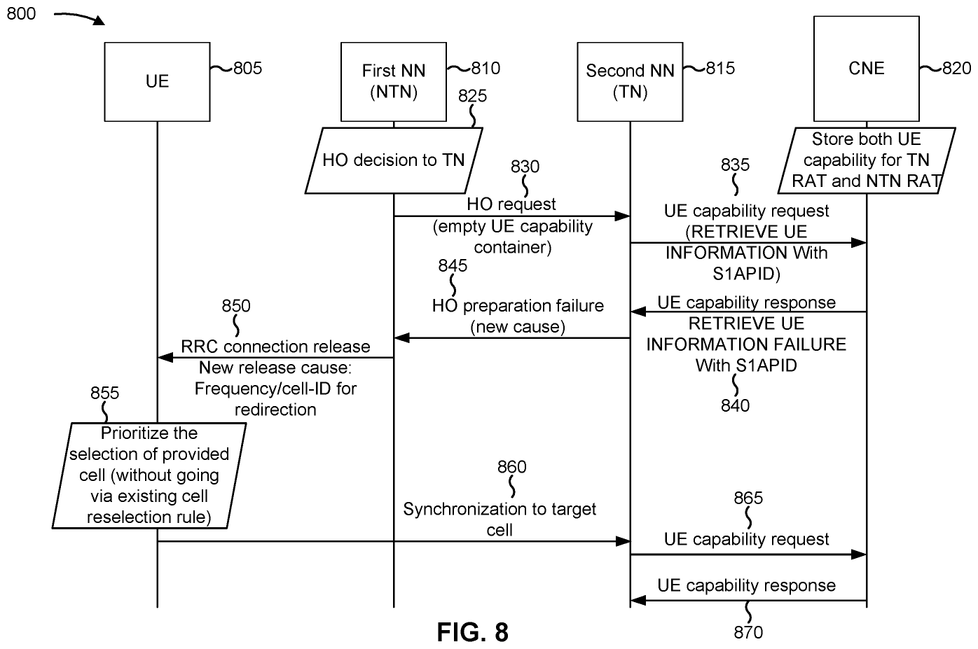

FIG. 8 is a diagram illustrating an example 800 of an RRC release based redirection mobility operation, in accordance with the present disclosure. An RRC release based redirection involves releasing an RRC connection with a source network node (e.g., such that the UE enters an idle mode) and indicating for the UE to establish an RRC connection with a target network node. The indication for the UE to establish the RRC connection with the target network node is referred to as a redirection to the target network node.

Example 800 includes a UE 805 (e.g., UE 120), a source network node 810 (e.g., network node 110), a target network node 815 (e.g., network node 110), and a core network entity 820 (e.g., the core network entity 410 of FIG. 4). The source network node is associated with an NTN and the target network node is associated with an TN. For example, the UE 805 may be connected to the NTN (e.g., the source network node associated with the NTN). As shown, in some examples, the core network entity 820 may store or have access to capability information, such as capability information associated with transferring from a TN to an NTN (e.g., capability information 505) and/or capability information associated with transferring from an NTN to a TN (e.g., capability information 535). In some aspects, the core network entity 820 may store or have access to only the capability information associated with transferring from the TN to the NTN. In some aspects, the core network entity 820 may store or have access to only the capability information associated with transferring from the NTN to the TN. In some aspects, the core network entity 820 may store or have access to the capability information associated with transferring from the TN to the NTN and the capability information associated with transferring from the NTN to the TN. The techniques described with regard to example 800 can also be applied for a mobility operation transferring the UE 805 from the TN to the NTN. For example, the source network node 810 may be associated with the TN and the target network node 815 may be associated with the NTN.

As shown, at reference number 825, the source network node 810 may determine to perform a mobility operation from the NTN to the TN, as described, for example, with regard to reference number 725 of FIG. 7.

As shown, the source network node 810 may provide a handover request 830 to the target network node 815. In some aspects (e.g., for S1-AP based handover), the source network node 810 may provide a handover required message to the core network entity 820. As shown, the target network node 815 may provide a UE capability request 835 to the core network entity 820. Thus, the target network node 815 may attempt to obtain, the capability information relating to the mobility operation of the UE transferring from the NTN to the TN.

As shown, the core network entity 820 may provide a UE capability response message 840 (e.g., a retrieve UE information failure message) to the target network node 815. For example, the core network entity 820 may not store, or may not have access to, capability information associated with transferring from the NTN to the TN. Thus, the target network node 815 may fail to obtain the capability information associated with transferring from the NTN to the TN. In this case, the target network node 815 may not be aware of whether the UE 805 supports the applicable bands or the network type (e.g., TN or NTN) associated with the target network node 815. In some aspects, the target network node 815 may initiate the redirection via an RRC release message to be sent by the source network node 810 based at least in part on failing to obtain the capability information.

As shown, the target network node 815 may provide a handover preparation failure message 845 to the source network node 810. initiating the redirection further comprises providing, to a source network node of the UE, a handover preparation failure message 845 (e.g., an X2AP or an S1AP handover failure message) indicating a release cause associated with failing to obtain the capability information. The release cause may indicate, for example, no UE capability (e.g., no capability information) is available to the target network node 815. Thus, the source network node 810 may obtain, from the target network node 815 of the mobility operation, an indication to initiate a redirection of the UE 805, wherein the indication indicates that the target network node 815 failed to obtain the capability information, and wherein the message for the UE 805 comprises a RRC connection release message (e.g., RRC connection release message 850). It may be up to the UE 805 whether the UE 805 can perform redirection to the indicated frequency, cell identifier, and/or network type (e.g., indicated by the RRC connection release message 850) based at least in part on whether the UE 805 supports the indicated frequency, cell identifier, and/or network type (e.g., TN or NTN). As shown, the source network node 810 may provide the RRC connection release message 850 to the UE 805.

In some aspects, the RRC connection release message 850 may include a dedicated frequency priority list. A dedicated frequency priority list is a list of frequencies. The dedicated frequency priority list may be specific to (e.g., dedicated to) the UE 805. The dedicated frequency priority list may indicate frequencies at which the UE 805 can receive paging messages from the network requesting that the UE 805 switch to an active mode. In some aspects, the dedicated frequency priority list may be specific to the TN (e.g., a TN using E-UTRA or NR). In some aspects, the dedicated frequency priority list may be specific to the NTN. In some aspects, the dedicated frequency priority list (e.g., an existing dedicated frequency priority list) may include an indication of whether the dedicated frequency priority list is associated with the TN or the NTN.

As shown by reference number 855, the UE 805 may prioritize selection of a cell indicated by the RRC connection release message 850. For example, the UE may perform cell reselection, and may prioritize selection of a cell associated with an indicated frequency, cell identifier, and/or frequency type.

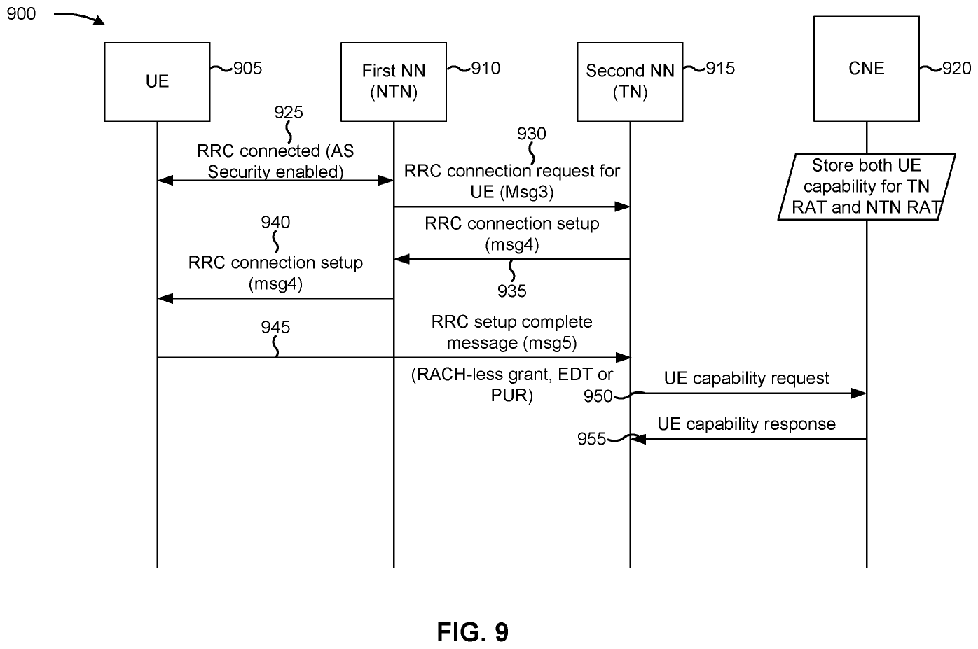

After redirection, the UE 805 may switch to a TN mode (or an NTN mode) from an NTN mode (or a TN mode), depending on whether the UE 805 is transferred to a TN or an NTN. To switch the mode, a RAT type (indicating whether the target network node 815 is associated with the TN or the NTN) may be indicated to the UE 805. The RRC connection release message 850 may indicate a cell identifier associated with the target network node 815, a RAT type, and a core network (CN) type (e.g., 5GC, UTRA, E-UTRA, EPC) in redirection carrier information of the RRC connection release message 850. This can also be indicated in an EDT complete message or a PUR complete message, as described with regard to FIG. 9.

In some aspects, the mobility operation of example 800 may be implemented in the control plane (e.g., without access stratum security). In such examples, the mobility operation may include NAS message based redirection (e.g., using a NAS message to the source network node 810) with NAS security. For example, the target network node 815 and/or the core network entity 820 may provide a NAS message to the source network node 810 to initiate NAS message based redirection with NAS security.

As shown by reference number 860, the UE 805 may synchronize with the target network node 815, as described above with regard to reference number 760.

As shown, the target network node 815 may provide a UE capability request 865 to the core network entity 820. As shown, the core network entity 820 may provide a UE capability response 870 to the target network node 815. For example, the target network node 815 may request (and/or obtain) capability information of the UE 805, pertaining to mobility operations and/or other operations of the UE 805.

As indicated above, FIG. 8 is provided as an example. Other examples may differ from what is described with regard to FIG. 8.

FIG. 9 is a diagram illustrating an example 900 of a redirection mobility operation involving an EDT or a PUR, in accordance with the present disclosure. An EDT is a small data transmission (SDT) performed using random access resources. In some examples, an EDT may be referred to as random access based SDT. An EDT may involve data transmission using shared radio resources of a random access procedure. In some examples, the shared radio resources may be indicated via system information. An SDT can also be performed using a PUR. A PUR may be configured by one or more RRC parameters transmitted with an RRC connection suspend indication in an RRC release message. Thus, a PUR facilitates transmission from an RRC inactive state on a PUR. The techniques described with regard to example 900 can also be applied for a mobility operation transferring the UE 905 from the TN to the NTN. For example, the source network node 910 may be associated with the TN and the target network node 915 may be associated with the NTN.

Example 900 includes a UE 905 (e.g., UE 120), a source network node 910 (e.g., network node 110), a target network node 915 (e.g., network node 110), and a core network entity 920 (e.g., the core network entity 410 of FIG. 4). The source network node is associated with an NTN, and the target network node is associated with an TN. For example, the UE 905 may be connected to the NTN (e.g., the source network node associated with the NTN). As shown, in some examples, the core network entity 920 may store or have access to capability information, such as capability information associated with transferring from a TN to an NTN (e.g., capability information 505) and/or capability information associated with transferring from an NTN to a TN (e.g., capability information 535). In some aspects, the core network entity 920 may store or have access to only the capability information associated with transferring from the TN to the NTN. In some aspects, the core network entity 920 may store or have access to only the capability information associated with transferring from the NTN to the TN. In some aspects, the core network entity 920 may store or have access to the capability information associated with transferring from the TN to the NTN and the capability information associated with transferring from the NTN to the TN.

As shown by reference number 925, the UE may be in an RRC connected state, with access stratum (AS) security enabled, with the source network node 910.

As shown, the source network node 910 may provide an RRC connection request 930 for the UE 905 to the target network node 915. In some aspects, the RRC connection request 930 may include or be based on a Msg3 of a four-step RACH procedure. In some aspects, the RRC connection request 930 may indicate an EDT resource (e.g., a shared radio resource), a PUR resource (e.g., a shared radio resource), or an uplink grant (e.g., a RACH-less uplink grant) for the target network node 915. For example, if the source network node 910 can determine the UE 905's location, and if the UE 905 is moving from an NTN (e.g., a coverage area or cell of an NTN) to a TN (e.g., a coverage area or cell of a TN), then an EDT, a PUR, and/or a RACH-less uplink grant can also be enabled for use by the target network node 915 to facilitate the mobility operation. In this example, the source network node 910 may perform handover preparation (that is, Msg3 and the RRC connection setup message 940 are communicated between the source network node 910 and the target network node 915). Thus, the source network node 910 may trigger the mobility operation by outputting, for the target network node 915 of the mobility operation, an EDT configuration (e.g., a resource for an EDT) or a PUR for an RRC setup complete message 945, of the UE 905, associated with the mobility operation.

As shown, the target network node 915 may provide an RRC connection setup message 935 to the source network node 910. For example, the source network node 910 may obtain the RRC connection setup message 935 from the target network node 915 prior to outputting the RRC connection setup message 935 to the UE 905. The source network node 910 may then forward the RRC connection setup message 935 (e.g., Msg4) to the UE 905. The RRC connection setup message 935 may be referred to as a message.

As shown, the UE 905 may provide an RRC setup complete message 945 to the target network node 915. For example, the UE may provide the RRC setup complete message 945 to the target network node 915 as a Msg5 (e.g., a fifth step) of a four-step RACH procedure (e.g., without transmitting a Msg3 of the four-step RACH procedure).

As shown, the target network node 915 may provide a UE capability request 950 to the core network entity 920. As shown, the core network entity 920 may provide a UE capability response 955 to the target network node 915. For example, the target network node 915 may request (and/or obtain) capability information of the UE 905, pertaining to mobility operations and/or other operations of the UE 905.

As indicated above, FIG. 9 is provided as an example. Other examples may differ from what is described with regard to FIG. 9.

The source network nodes, target network nodes, and UEs of FIGS. 5-9 are described as performing “at least part of a mobility operation.” For a given device or node, performing at least part of a mobility operation includes transmissions (e.g., outputs), receptions (e.g., inputs, obtaining information), and determinations shown in FIGS. 5-9 as being performed by the given device or node. For example, in FIG. 6, the source network node 610 may perform at least part of a mobility operation by one or more of: providing the handover request 625, making a handover decision, obtaining a handover request acknowledgment 640, and outputting a handover command 645, among other operations described with regard to FIG. 6 and/or impacting the source network node 610 as part of the mobility operation.

While the operations of FIGS. 5-9 are described with regard to a mobility operation involving transferring from an NTN to a TN, it should be understood that these operations can also be applied for transferring from a TN to an NTN. In such implementations, the source network node may be associated with the TN and the target network node may be associated with the NTN. The capability information, instead of indicating whether the UE supports a mobility operation involving transferring the UE from an NTN to a TN, may indicate whether the UE supports a mobility operation involving transferring the UE from a TN to an NTN.

FIG. 10 is a diagram illustrating an example process 1000 performed, for example, by a network node, in accordance with the present disclosure. Example process 1000 is an example where the network node (e.g., network node 110, target network node of FIG. 5, target network node 615, target network node 715, target network node 815, target network node 915) performs operations associated with terrestrial network and non-terrestrial network mobility.

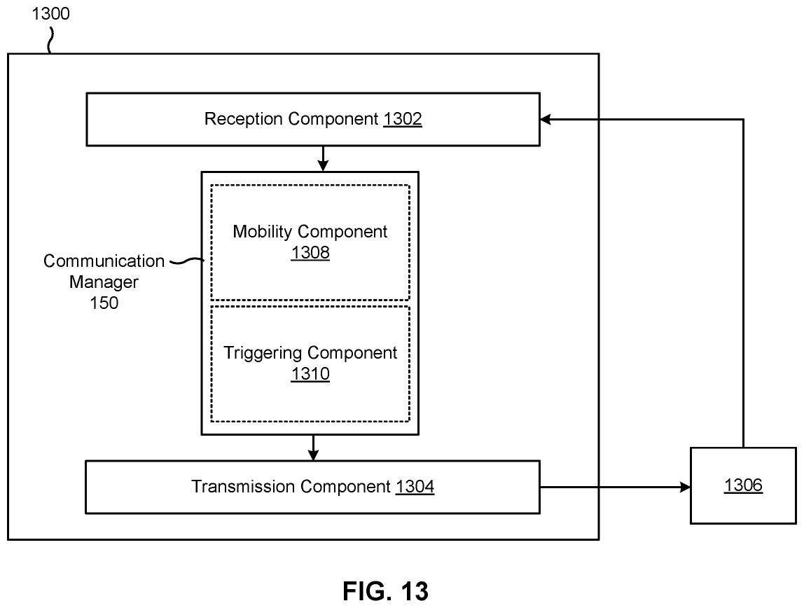

As shown in FIG. 10, in some aspects, process 1000 may include attempting to obtain capability information relating to a mobility operation of a UE transferring between an NTN and a TN (block 1010). For example, the network node (e.g., using communication manager 150 and/or reception component 1302, depicted in FIG. 13) may attempt to obtain capability information relating to a mobility operation of a UE transferring from an NTN to a TN, or from a TN to an NTN, as described above.

As further shown in FIG. 10, in some aspects, process 1000 may include performing at least part of the mobility operation based at least in part on the capability information or attempting to obtain the capability information (block 1020). For example, the network node (e.g., using communication manager 150 and/or mobility component 1308, depicted in FIG. 13) may perform at least part of the mobility operation based at least in part on the capability information or attempting to obtain the capability information, as described above.

Process 1000 may include additional aspects, such as any single aspect or any combination of aspects described below and/or in connection with one or more other processes described elsewhere herein.

In a first aspect, the capability information indicates whether the UE supports transferring from an NTN to a TN radio access technology associated with at least one of an EPC, a 5G core, or an Evolved Universal Mobile Telecommunications System (UMTS) Terrestrial Radio Access (UTRA) (E-UTRA) technology.

In a second aspect, alone or in combination with the first aspect, attempting to obtain the capability information further comprises requesting the capability information from a core network entity.

In a third aspect, alone or in combination with one or more of the first and second aspects, the network node is a target network node of the mobility operation and requesting the capability information from the core network entity is based at least in part on an indication, from a source network node of the UE, that the capability information is not available at the source network node.

In a fourth aspect, alone or in combination with one or more of the first through third aspects, the indication that the capability information is not available at the source network node is an omission of a radio capability (e.g., an empty capability container) of the UE in a handover preparation message.

In a fifth aspect, alone or in combination with one or more of the first through fourth aspects, the indication that the capability information is not available at the source network node is an indication that the source network node is associated with a different network type than the target network node.

In a sixth aspect, alone or in combination with one or more of the first through fifth aspects, requesting the capability information from the core network entity is based at least in part on the mobility operation being from the NTN to the TN.

In a seventh aspect, alone or in combination with one or more of the first through sixth aspects, process 1000 includes determining that the mobility operation is from the NTN to the TN based at least in part on an indication, from a source network node of the UE, of whether the source network node is associated with the NTN or the TN.

In an eighth aspect, alone or in combination with one or more of the first through seventh aspects, process 1000 includes triggering a handover associated with a minimum required capability for an RRC connection based at least in part on failing to obtain the capability information.

In a ninth aspect, alone or in combination with one or more of the first through eighth aspects, the capability information indicates that the UE does not support a band of a target radio access technology of the TN and the NTN, and wherein performing at least part of the mobility operation further comprises requesting that a source network node or a core network entity, associated with the UE, release the UE to an idle mode.

In a tenth aspect, alone or in combination with one or more of the first through ninth aspects, attempting to obtain the capability information comprises receiving the capability information from a core network entity.

In a eleventh aspect, alone or in combination with one or more of the first through tenth aspects, performing at least part of the mobility operation comprises at least one of outputting an acknowledgment associated with the capability information, or synchronizing with the UE.

In a twelfth aspect, alone or in combination with one or more of the first through eleventh aspects, process 1000 includes failing to obtain the capability information and initiating a redirection of the UE based at least in part on failing to obtain the capability information.

In an thirteenth aspect, alone or in combination with one or more of the first through twelfth aspects, initiating the redirection further comprises providing a radio resource control (RRC) release message with redirection information to the UE.

In a fourteenth aspect, alone or in combination with one or more of the first through thirteenth aspects, the redirection information includes one or more of: a dedicated frequency priority list of the TN, a dedicated frequency priority list of the NTN, or an NTN indication, in an existing dedicated frequency priority list, indicating whether the existing dedicated frequency priority list is for the NTN or the TN.

In a fifteenth aspect, alone or in combination with one or more of the first through fourteenth aspects, initiating the redirection further comprises providing, to a source network node of the UE, a handover failure message indicating a release cause associated with failing to obtain the capability information.

In a sixteenth aspect, alone or in combination with one or more of the first through fifteenth aspects, initiating the redirection of the UE further comprises providing an NAS message to a source network node of the UE.

In a seventeenth aspect, alone or in combination with one or more of the first through sixteenth aspects, the mobility operation includes a handover or a redirection from a cell associated with the NTN to a cell associated with the TN.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110, source network node of FIG. 5, source network node 610, source network node 710, source network node 810, source network node 910) performs operations associated with terrestrial network and non-terrestrial network mobility.

As shown in FIG. 11, in some aspects, process 1100 may include triggering a mobility operation associated with transferring a UE between an NTN and a TN based at least in part on at least one of: capability information associated with the UE and relating to the mobility operation, or whether the capability information is available to the network node (block 1110). For example, the network node (e.g., using communication manager 150 and/or triggering component 1310, depicted in FIG. 13) may trigger a mobility operation associated with transferring a UE from an NTN to a TN (or from a TN to an NTN) based at least in part on at least one of: capability information associated with the UE and relating to the mobility operation, or whether the capability information is available to the network node, as described above.

As further shown in FIG. 11, in some aspects, process 1100 may include outputting a message for the UE based at least in part on the capability information (block 1120). For example, the network node (e.g., using communication manager 150 and/or transmission component 1304, depicted in FIG. 13) may output a message for the UE based at least in part on the capability information, as described above.

Process 1100 may include additional aspects, such as any single aspect or any combination of aspects described below and/or in connection with one or more other processes described elsewhere herein.

In a first aspect, triggering the mobility operation further comprises outputting, to a target network node of the mobility operation, a handover request including an empty UE capability container based at least in part on the capability information not being available to the network node.

In a second aspect, alone or in combination with the first aspect, process 1100 includes obtaining, from a target network node of the mobility operation, an indication to release the UE to an idle mode based at least in part on the capability information indicating that the UE cannot transfer from the NTN to the TN.

In a third aspect, alone or in combination with one or more of the first and second aspects, process 1100 includes requesting the capability information from a core network entity based at least in part on the capability information not being available to the network node.

In a fourth aspect, alone or in combination with one or more of the first through third aspects, process 1100 includes determining that the capability information is not received, wherein the message comprises an indication for the UE to enter an idle mode based at least in part on the capability information not being available to the network node.

In a fifth aspect, alone or in combination with one or more of the first through fourth aspects, triggering the mobility operation further comprises outputting a handover required message to a core network entity.

In a sixth aspect, alone or in combination with one or more of the first through fifth aspects, the handover required message indicates that the mobility operation is from the NTN to the TN.

In a seventh aspect, alone or in combination with one or more of the first through sixth aspects, process 1100 includes obtaining, from a target network node of the mobility operation, an indication to initiate a redirection of the UE, wherein the indication indicates that the target network node failed to obtain the capability information, and wherein the message for the UE comprises an RRC connection release.

In an eighth aspect, alone or in combination with one or more of the first through seventh aspects, triggering the mobility operation further comprises outputting, for a target network node of the mobility operation, an early data transmission configuration or a preconfigured uplink resource for an RRC setup complete message, of the UE, associated with the mobility operation, and wherein the message comprises an RRC connection setup message associated with the mobility operation.

In a ninth aspect, alone or in combination with one or more of the first through eighth aspects, process 1100 includes obtaining the RRC connection setup message from the target network node prior to outputting the RRC connection setup message.

In a tenth aspect, alone or in combination with one or more of the first through ninth aspects, the mobility operation omits a RACH procedure.

In an eleventh aspect, alone or in combination with one or more of the first through tenth aspects, the capability information indicates that the UE does not support a band of a target radio access technology of the TN and the NTN, and wherein performing at least part of the mobility operation further comprises requesting that a core network entity, associated with the UE, release the UE to an idle mode.

In a twelfth aspect, alone or in combination with one or more of the first through eleventh aspects, process 1100 includes requesting the capability information from a core network entity, wherein the capability information is not received from the core network entity, and wherein performing at least part of the mobility operation further comprises requesting that the core network entity release the UE to an idle mode.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120, the UE of FIG. 5, UE 605, UE 705, UE 805, UE 905) performs operations associated with terrestrial network and non-terrestrial network mobility.

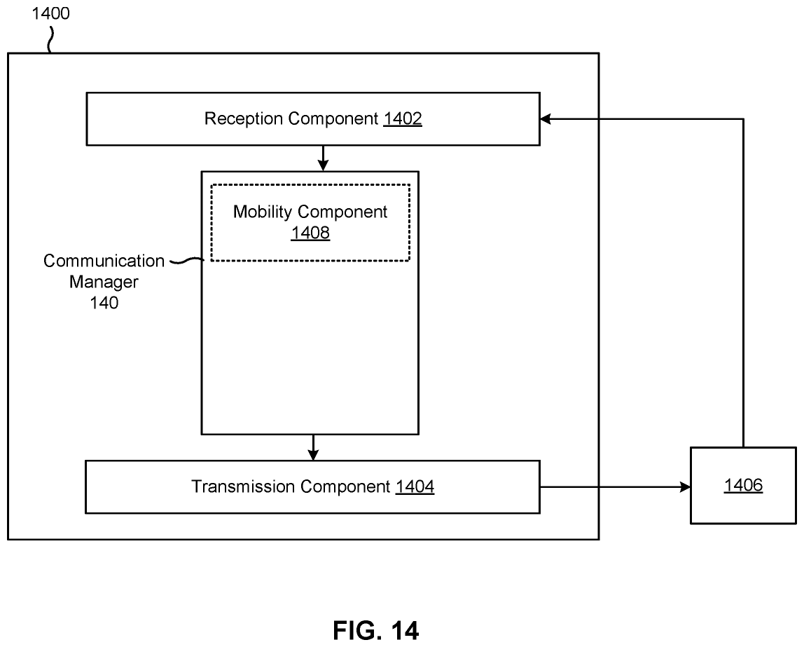

As shown in FIG. 12, in some aspects, process 1200 may include receiving a trigger for a mobility operation associated with the UE transferring between an NTN and a TN (block 1210). For example, the UE (e.g., using communication manager 140 and/or reception component 1402, depicted in FIG. 14) may receive a trigger for a mobility operation associated with the UE from an NTN to a TN or from a TN to an NTN, as described above. The trigger may include, for example, a handover command received from a network node (such as a source network node or a target network node described elsewhere herein). The mobility operation may include a handover, an RRC reestablishment, a redirection, or the like.

As further shown in FIG. 12, in some aspects, process 1200 may include performing at least part of the mobility operation based at least in part on having transmitted capability information indicating a capability of the UE associated with the mobility operation (block 1220). For example, the UE (e.g., using communication manager 140 and/or mobility component 1408, depicted in FIG. 14) may perform at least part of the mobility operation based at least in part on having transmitted capability information indicating a capability of the UE associated with the mobility operation, as described above. For example, the UE may memorize (e.g., store information indicating) whether the UE has reported capability information in only a TN, only an NTN, or both the TN and the NTN. If the UE has transmitted capability information to a network node associated with a network (e.g., a TN or an NTN), and if the trigger for the mobility operation is received from the network node associated with the network, then the UE may perform at least part of the mobility operation for the network.

As further shown in FIG. 12, in some aspects, process 1200 may include aborting the mobility operation based at least in part on not having transmitted the capability information (block 1230). For example, the UE (e.g., using communication manager 140 and/or mobility component 1408, depicted in FIG. 14) may abort the mobility operation based at least in part on not having transmitted the capability information, as described above. If the UE has not transmitted capability information to a network node associated with a network (e.g., a TN or an NTN), and if the trigger for the mobility operation is received from the network node associated with the network, then the UE may abort the mobility operation for the network (e.g., may ignore the trigger).

Process 1200 may include additional aspects, such as any single aspect or any combination of aspects described below and/or in connection with one or more other processes described elsewhere herein.

In a first aspect, aborting the mobility operation further comprises aborting the mobility operation based at least in part on receiving the trigger from a network node, and based at least in part on not having transmitted the capability information to the network node from which the trigger was received.

In a second aspect, alone or in combination with the first aspect, aborting the mobility operation further comprises initiating a tracking area update procedure. For example, the UE may initiate the tracking area update procedure if the UE has not reported capability information (e.g., associated with transferring from an NTN to a TN, or from a TN to an NTN) to a network from which a trigger for a mobility operation is received.

In a third aspect, alone or in combination with one or more of the first and second aspects, the mobility operation is a radio resource control reestablishment after a radio link failure. For example, after radio link failure, the UE may abort a triggered RRC reestablishment and initiate a tracking area update procedure if the UE has not reported capability information to a network for which the UE experienced the radio link failure.

In a fourth aspect, alone or in combination with one or more of the first through third aspects, process 1200 includes transmitting the capability information during a tracking area update procedure. For example, during a tracking area update procedure associated with a network, the UE may trigger a UE capability update procedure for the network. In this example, the UE may include a capability information in an uplink message (e.g., associated with the tracking area update procedure) without having received a network request, which may conserve overhead associated with the UE reporting the capability after receiving a network request (since the network request needs not be transmitted).

In a fifth aspect, alone or in combination with one or more of the first through fourth aspects, process 1200 includes transmitting, prior to receiving the trigger, information indicating a preference associated with performing the mobility operation, wherein the mobility operation comprises a redirection based at least in part on the preference. For example, the preference may indicate whether or not the UE prefers to perform a handover from an NTN to a TN (e.g., separately from a capability for the mobility operation). If the preference indicates not to perform a handover, the network (e.g., a source network node, described elsewhere herein) may release the UE with a redirection, as described elsewhere herein. For example, the network may release the UE with a redirection instead of performing a basic handover (e.g., with a minimum capability, as described elsewhere herein). In this case, the network may not be aware which TN bands are supported or not supported by the UE or whether a 5GC is supported or not supported by the UE. Thus, the network may release the UE with redirection to an NTN so that the UE can determine whether to connect to a redirected or target cell associated with the release.

In a sixth aspect, alone or in combination with one or more of the first through fifth aspects, the trigger indicates a cell identifier and an RAT type of a target network node of the mobility operation, wherein the RAT type indicates whether the target network node is associated with the TN or the NTN.

In a seventh aspect, alone or in combination with one or more of the first through sixth aspects, the trigger comprises an early data transmission complete message or a preconfigured uplink resource complete message (as described, for example, with regard to FIG. 9).

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include one or more of a mobility component 1308 or a triggering component 1310, among other examples.

In some aspects, the apparatus 1300 may be configured to perform one or more operations described herein in connection with FIGS. 4-9. Additionally, or alternatively, the apparatus 1300 may be configured to perform one or more processes described herein, such as process 1000 of FIG. 10, process 1100 of FIG. 11, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The reception component 1302 may attempt to obtain capability information relating to a mobility operation of a UE transferring from an NTN to a TN. The mobility component 1308 may perform at least part of the mobility operation based at least in part on the capability information or attempting to obtain the capability information.

The triggering component 1310 may trigger a mobility operation associated with transferring a UE from an NTN to a TN based at least in part on at least one of capability information associated with the UE and relating to the mobility operation, or whether the capability information is available to the network node. The transmission component 1304 may output a message for the UE based at least in part on the capability information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a mobility component 1408, among other examples.

In some aspects, the apparatus 1400 may be configured to perform one or more operations described herein in connection with FIGS. 4-9. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receiving a trigger for a mobility operation associated with the apparatus 1400 from an NTN to a TN. The mobility component 1408 may perform at least part of the mobility operation based at least in part on having transmitted capability information indicating a capability of the UE associated with the mobility operation. Alternatively, the mobility component 1408 may abort the mobility operation based at least in part on not having transmitted the capability information.

The transmission component 1404 may transmit the capability information during a tracking area update procedure.

The transmission component 1404 may transmit, prior to receiving the trigger, information indicating a preference associated with performing the mobility operation, wherein the mobility operation comprises a redirection based at least in part on the preference.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a network node, comprising: attempting to obtain capability information relating to a mobility operation of a user equipment (UE) transferring between a non-terrestrial network (NTN) and a terrestrial network (TN); and performing at least part of the mobility operation based at least in part on the capability information or attempting to obtain the capability information.

Aspect 2: The method of Aspect 1, wherein the capability information indicates whether the UE supports transferring from an NTN to a TN radio access technology associated with at least one of an evolved packet core (EPC), a 5G core, or an Evolved Universal Mobile Telecommunications System (UMTS) Terrestrial Radio Access technology.

Aspect 3: The method of any of Aspects 1-2, wherein attempting to obtain the capability information further comprises requesting the capability information from a core network entity.

Aspect 4: The method of Aspect 3, wherein the network node is a target network node of the mobility operation and wherein requesting the capability information from the core network entity is based at least in part on an indication, from a source network node of the UE, that the capability information is not available at the source network node.

Aspect 6: The method of Aspect 4, wherein the indication that the capability information is not available at the source network node is an indication that the source network node is associated with a different network type than the target network node.

Aspect 7: The method of Aspect 3, wherein requesting the capability information from the core network entity is based at least in part on the mobility operation being from the NTN to the TN.

Aspect 8: The method of Aspect 7, further comprising determining that the mobility operation is from the NTN to the TN based at least in part on an indication, from a source network node of the UE, of whether the source network node is associated with the NTN or the TN.

Aspect 9: The method of any of Aspects 1-8, further comprising failing to obtain the capability information, wherein performing at least part of the mobility operation further comprises triggering a handover associated with a minimum required capability for a radio resource control (RRC) connection based at least in part on failing to obtain the capability information.

Aspect 10: The method of any of Aspects 1-8, wherein the capability information indicates that the UE does not support a band of a target radio access technology of the TN and the NTN, and wherein performing at least part of the mobility operation further comprises requesting that a source network node or a core network entity, associated with the UE, release the UE to an idle mode.

Aspect 11: The method of any of Aspects 1-10, wherein attempting to obtain the capability information comprises receiving the capability information from a core network entity.

Aspect 12: The method of Aspect 11, wherein performing at least part of the mobility operation comprises at least one of: outputting an acknowledgment associated with the capability information, or synchronizing with the UE.

Aspect 13: The method of any of Aspects 1-8, further comprising failing to obtain the capability information, wherein performing at least part of the mobility operation further comprises initiating a redirection of the UE based at least in part on failing to obtain the capability information.

Aspect 14: The method of Aspect 13, wherein initiating the redirection further comprises providing a radio resource control (RRC) release message with redirection information to the UE.

Aspect 15: The method of Aspect 14, wherein the redirection information includes one or more of: a dedicated frequency priority list of the TN, a dedicated frequency priority list of the NTN, or an NTN indication, in an existing dedicated frequency priority list, indicating whether the existing dedicated frequency priority list is for the NTN or the TN.

Aspect 16: The method of Aspect 13, wherein initiating the redirection further comprises providing, to a source network node of the UE, a handover failure message indicating a release cause associated with failing to obtain the capability information.

Aspect 17: The method of Aspect 13, wherein initiating the redirection of the UE further comprises providing a non access stratum (NAS) message to a source network node of the UE.

Aspect 18: The method of any of Aspects 1-17, wherein the mobility operation includes a handover or a redirection from a cell associated with the NTN to a cell associated with the TN.

Aspect 19: A method of wireless communication performed by a network node, comprising: triggering a mobility operation associated with transferring a user equipment (UE) between a non-terrestrial network (NTN) and a terrestrial network (TN) based at least in part on at least one of: capability information associated with the UE and relating to the mobility operation, or whether the capability information is available to the network node; and outputting a message for the UE based at least in part on the capability information.

Aspect 20: The method of Aspect 19, wherein triggering the mobility operation further comprises outputting, to a target network node of the mobility operation, a handover request including an empty UE capability container based at least in part on the capability information not being available to the network node.

Aspect 21: The method of any of Aspects 19-20, further comprising obtaining, from a target network node of the mobility operation, an indication to release the UE to an idle mode based at least in part on the capability information indicating that the UE cannot transfer from the NTN to the TN.

Aspect 22: The method of any of Aspects 19-21, further comprising requesting the capability information from a core network entity based at least in part on the capability information not being available to the network node.

Aspect 23: The method of Aspect 22, further comprising determining that the capability information is not received, wherein the message comprises an indication for the UE to enter an idle mode based at least in part on the capability information not being available to the network node.

Aspect 24: The method of any of Aspects 19-23, wherein triggering the mobility operation further comprises outputting a handover required message to a core network entity.

Aspect 25: The method of Aspect 24, wherein the handover required message indicates that the mobility operation is from the NTN to the TN.

Aspect 26: The method of any of Aspects 19-25, further comprising obtaining, from a target network node of the mobility operation, an indication to initiate a redirection of the UE, wherein the indication indicates that the target network node failed to obtain the capability information, and wherein the message for the UE comprises a radio resource control (RRC) connection release.

Aspect 27: The method of any of Aspects 19-26, wherein triggering the mobility operation further comprises outputting, for a target network node of the mobility operation, an early data transmission configuration or a preconfigured uplink resource for a radio resource control (RRC) setup complete message, of the UE, associated with the mobility operation, and wherein the message comprises an RRC connection setup message associated with the mobility operation.

Aspect 28: The method of Aspect 27, further comprising obtaining the RRC connection setup message from the target network node prior to outputting the RRC connection setup message.

Aspect 29: The method of Aspect 27, wherein the mobility operation omits a random access channel (RACH) procedure.

Aspect 30: The method of any of Aspects 19-29, wherein the capability information indicates that the UE does not support a band of a target radio access technology of the TN and the NTN, and wherein performing at least part of the mobility operation further comprises requesting that a core network entity, associated with the UE, release the UE to an idle mode.

Aspect 31: The method of any of Aspects 19-30, further comprising requesting the capability information from a core network entity, wherein the capability information is not received from the core network entity, and wherein performing at least part of the mobility operation further comprises requesting that the core network entity release the UE to an idle mode.

Aspect 32: A method of wireless communication performed by a user equipment (UE), comprising: receiving a trigger for a mobility operation associated with the UE between a non-terrestrial network (NTN) and a terrestrial network (TN); and performing at least part of the mobility operation based at least in part on having transmitted capability information indicating a capability of the UE associated with the mobility operation or aborting the mobility operation based at least in part on not having transmitted the capability information.

Aspect 33: The method of Aspect 32, wherein aborting the mobility operation further comprises aborting the mobility operation based at least in part on receiving the trigger from a network node, and based at least in part on not having transmitted capability information associated with a target network type of the mobility operation.

Aspect 34: The method of any of Aspects 32-33, wherein aborting the mobility operation further comprises initiating a tracking area update procedure.

Aspect 35: The method of any of Aspects 32-34, wherein the mobility operation is a radio resource control reestablishment after a radio link failure.

Aspect 36: The method of any of Aspects 32-35, further comprising transmitting the capability information during a tracking area update procedure.

Aspect 37: The method of any of Aspects 32-36, further comprising transmitting, prior to receiving the trigger, information indicating a preference associated with performing the mobility operation, and wherein the mobility operation comprises a redirection based at least in part on the preference.

Aspect 38: The method of any of Aspects 32-37, wherein the trigger indicates a cell identifier and a radio access technology (RAT) type of a target network node of the mobility operation, wherein the RAT type indicates whether the target network node is associated with the TN or the NTN.

Aspect 39: The method of Aspect 38, wherein the trigger comprises an early data transmission complete message or a preconfigured uplink resource complete message.

Aspect 40: An apparatus for wireless communication at a device, comprising a processor: memory coupled with the processor: and instructions stored in the memory and executable by the processor to cause the apparatus to perform the method of one or more of Aspects 1-39.

Aspect 41: A device for wireless communication, comprising a memory and one or more processors coupled to the memory, the one or more processors configured to perform the method of one or more of Aspects 1-39.

Aspect 42: An apparatus for wireless communication, comprising at least one means for performing the method of one or more of Aspects 1-39.

Aspect 43: A non-transitory computer-readable medium storing code for wireless communication, the code comprising instructions executable by a processor to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

Aspect 45: The method of one or more of Aspects 1-39, wherein the capability information indicates whether the UE supports a same set of capabilities, for performing mobility operations, for an NTN radio access technology and a TN radio access technology.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or.” unless explicitly stated otherwise (e.g., if used in combination with “cither” or “only one of”).

What is claimed is:

1. A network node for wireless communication, comprising:
a memory; and
one or more processors, coupled to the memory, configured to:
attempt to obtain capability information relating to a mobility operation of a user equipment (UE) transferring between a non-terrestrial network (NTN) and a terrestrial network (TN); and
perform at least part of the mobility operation based at least in part on the capability information or attempting to obtain the capability information.

2. The network node of claim 1, wherein the capability information indicates whether the UE supports transferring from an NTN to a TN radio access technology associated with at least one of an evolved packet core (EPC), a 5G core, or an Evolved Universal Mobile Telecommunications System (UMTS) Terrestrial Radio Access technology.

3. The network node of claim 2, wherein the capability information indicates whether the UE supports a same set of capabilities, for performing mobility operations, for an NTN radio access technology and a TN radio access technology.

4. The network node of claim 1, wherein the one or more processors, to attempt to obtain the capability information, are configured to request the capability information from a core network entity.

5. The network node of claim 4, wherein the network node is a target network node of the mobility operation and wherein requesting the capability information from the core network entity is based at least in part on an indication, from a source network node of the UE, that the capability information is not available at the source network node.

6. The network node of claim 5, wherein the indication that the capability information is not available at the source network node is an omission of a radio capability of the UE in a handover preparation message.

7. The network node of claim 5, wherein the indication that the capability information is not available at the source network node is an indication that the source network node is associated with a different network type than the target network node.

8. The network node of claim 4, wherein requesting the capability information from the core network entity is based at least in part on the mobility operation being from the NTN to the TN.

9. The network node of claim 1, wherein the one or more processors are further configured to fail to obtain the capability information, wherein, to perform at least part of the mobility operation, the one or more processors are further configured to trigger a handover associated with a minimum required capability for a radio resource control (RRC) connection based at least in part on failing to obtain the capability information.

10. The network node of claim 1, wherein the capability information indicates that the UE does not support a band of a target radio access technology of the TN and the NTN, and wherein the one or more processors, to perform at least part of the mobility operation, are configured to request that a source network node or a core network entity, associated with the UE, release the UE to an idle mode.

11. The network node of claim 1, wherein the one or more processors, to attempt to obtain the capability information, are configured to receive the capability information from a core network entity.

12. The network node of claim 1, wherein the one or more processors are further configured to fail to obtain the capability information, wherein the one or more processors, to perform at least part of the mobility operation, are further configured to initiate a redirection of the UE based at least in part on failing to obtain the capability information.

13. The network node of claim 12, wherein the one or more processors, to initiate the redirection, are configured to provide a radio resource control (RRC) release message with redirection information to the UE.

14. The network node of claim 13, wherein the redirection information includes one or more of:
a dedicated frequency priority list of the TN,
a dedicated frequency priority list of the NTN, or
an NTN indication, in an existing dedicated frequency priority list, indicating whether the existing dedicated frequency priority list is for the NTN or the TN.

15. A network node for wireless communication, comprising:
a memory; and
one or more processors, coupled to the memory, configured to:
trigger a mobility operation associated with transferring a user equipment (UE) between a non-terrestrial network (NTN) and a terrestrial network (TN) based at least in part on at least one of:
capability information associated with the UE and relating to the mobility operation, or
whether the capability information is available to the network node: and
output a message for the UE based at least in part on the capability information.

16. The network node of claim 15, wherein the one or more processors, to trigger the mobility operation, are configured to output, to a target network node of the mobility operation, a handover request including an empty UE capability container based at least in part on the capability information not being available to the network node.

17. The network node of claim 15, wherein the one or more processors are further configured to obtain, from a target network node of the mobility operation, an indication to release the UE to an idle mode based at least in part on the capability information indicating that the UE cannot transfer from the NTN to the TN.

18. The network node of claim 15, wherein the one or more processors are further configured to request the capability information from a core network entity based at least in part on the capability information not being available to the network node.

19. The network node of claim 15, wherein the one or more processors, to trigger the mobility operation, are configured to output a handover required message to a core network entity.

20. The network node of claim 15, wherein the one or more processors are further configured to obtain, from a target network node of the mobility operation, an indication to initiate a redirection of the UE, wherein the indication indicates that the target network node failed to obtain the capability information, and wherein the message for the UE comprises a radio resource control (RRC) connection release.

21. The network node of claim 15, wherein triggering the mobility operation further comprises outputting, for a target network node of the mobility operation, an early data transmission configuration or a preconfigured uplink resource for a radio resource control (RRC) setup complete message, of the UE, associated with the mobility operation, and wherein the message comprises an RRC connection setup message associated with the mobility operation.

22. The network node of claim 15, wherein the capability information indicates that the UE does not support a band of a target radio access technology of the TN and the NTN, and wherein the one or more processors, to perform at least part of the mobility operation, are configured to request that a core network entity, associated with the UE, release the UE to an idle mode.

23. The network node of claim 15, wherein the one or more processors are further configured to request the capability information from a core network entity, wherein the capability information is not received from the core network entity, and wherein performing at least part of the mobility operation wherein the one or more processors are further configured to request that the core network entity release the UE to an idle mode.

24. A user equipment (UE) for wireless communication, comprising:
a memory; and
one or more processors, coupled to the memory, configured to:
receive a trigger for a mobility operation associated with the UE between a non-terrestrial network (NTN) and a terrestrial network (TN); and
perform at least part of the mobility operation based at least in part on having transmitted capability information indicating a capability of the UE associated with the mobility operation, or
abort the mobility operation based at least in part on not having transmitted the capability information.

25. The UE of claim 24, wherein the one or more processors, to abort the mobility operation, are configured to abort the mobility operation based at least in part on receiving the trigger from a network node, and based at least in part on not having transmitted capability information associated with a target network type of the mobility operation.

26. The UE of claim 24, wherein the one or more processors, to abort the mobility operation, are configured to initiate a tracking area update procedure.

27. The UE of claim 24, wherein the mobility operation is a radio resource control reestablishment after a radio link failure.

28. A method of wireless communication performed by a network node, comprising:
attempting to obtain capability information relating to a mobility operation of a user equipment (UE) transferring between a non-terrestrial network (NTN) and a terrestrial network (TN); and
performing at least part of the mobility operation based at least in part on the capability information or attempting to obtain the capability information.

29. The method of claim 28, wherein the capability information indicates whether the UE supports transferring from an NTN to a TN radio access technology associated with at least one of an evolved packet core (EPC), a 5G core, or an Evolved Universal Mobile Telecommunications System (UMTS) Terrestrial Radio Access technology.

30. The method of claim 28, wherein attempting to obtain the capability information further comprises requesting the capability information from a core network entity.
